(19) United States
(12) Patent Application Publication
(10) Pub. No.: US 2014/0354037 A1
(43) Pub. Date: Dec. 4, 2014

(54) SOLENOID VALVE

(71) Applicant: HYUNDAI MOBIS CO., LTD., Seoul (KR)

(72) Inventor: MOO CHUL KAM, Yongin-si (KR)

(73) Assignee: HYUNDAI MOBIS CO., LTD., Seoul (KR)

(21) Appl. No.: 14/088,281

(22) Filed: Nov. 22, 2013

(30) Foreign Application Priority Data
May 28, 2013 (KR) 10-2013-0060549

(51) Int. Cl. B60T 8/36

(52) U.S. Cl. CPC B60T 8/363
USPC 303/119.1

(57) ABSTRACT

A solenoid valve includes: a valve body; a plunger inserted into the valve body so as to reciprocate inside the valve body; a pump housing connected to the valve body and having an inlet and outlet formed therein; and a seat member mounted on the pump housing and changing the moving direction of fluid introduced through the inlet toward the plunger.

### CROSS-REFERENCES TO RELATED APPLICATIONS

The present application claims priority to Korean application number 10-2013-0060549, filed on May 8, 2013, which is incorporated by reference in its entirety.

### BACKGROUND OF THE INVENTION

The present invention relates to a solenoid valve, and more particularly, to a solenoid valve capable of linearly controlling the pressure of fluid acting on a wheel of a vehicle.

In general, a brake system of a vehicle using oil pressure applies a frictional force to a rotating wheel so as to restrict the rotation of the wheel. Recently, various techniques and methods have been used to control the pressure of brake fluid during a brake operation, in order to improve the stability of the vehicle while overcoming the limit of the brake system.

For example, the various techniques and methods may include an anti-lock brake system (ABS), a traction control system (TCS), an electronic stability program (ESP) and the like. The ABS properly controls a brake pressure applied to a wheel according to a slip ratio calculated from wheel speed, and prevents locking of the wheel. The TCS controls the drivability of an engine, in order to prevent an excessive slip when a sudden unintended acceleration (SUA) or sudden acceleration occurs in a vehicle. The ESP minimizes a difference between a driving direction intended by a driver and an actual driving direction of a vehicle, and stably maintains the driving direction intended by the driver under any driving conditions.

In order to control the brake pressure, various solenoid valves may be installed on a hydraulic circuit formed between a wheel cylinder to restrict the movement of a disk wheel and a master cylinder to generate oil pressure, and a flow path through which fluid is supplied from the master cylinder to the wheel cylinder and returned from the wheel cylinder to the master cylinder may be implemented.

At this time, an engine control unit (ECU) is used to control oil pressure on the hydraulic circuit as well as electronic elements for performing a brake operation.

The ECU reads wheel speed, performs calculation, analysis, and determination according to an embedded control program, drives a fluid pump while controlling on/off of a solenoid valve, and controls the fluid pressure on a hydraulic line.

In the solenoid valve, a valve body part forming a flow path is coupled to the fluid pump, and a coil is coupled to the ECU having a control circuit provided therein. When the coil is excited, the internal flow path of the valve body is opened to form a flow path in the fluid pump.

The coil is wound around a bobbin, the bobbin is housed in a case and installed on the outer wall of a housing of the fluid pump, and a stopper is interposed between the bobbin and the housing.

The related art of the present invention is disclosed in Korean Patent Laid-open Publication No. 2005-0045763 published on May 17, 2005, and entitled “Coil assembly fixing device of solenoid valve for electronic control brake system”.

Since the conventional solenoid valve is operated according to the on/off control method, the fluid pressure is rapidly varied. Thus, the conventional solenoid valve makes loud operation noise. Furthermore, since impact is transmitted to a brake pedal or the like, the conventional solenoid valve has a poor pedal feel. Furthermore, the fluid pressure applied to the wheel is difficult to linearly control.

Therefore, there is a demand for a structure capable of solving such problems.

### SUMMARY OF THE INVENTION

Embodiments of the present invention are directed to a solenoid valve which is capable of linearly controlling the pressure of fluid, thereby reducing operation noise and improving a pedal feel.

In one embodiment, a solenoid valve includes: a valve body; a plunger inserted into the valve body so as to reciprocate inside the valve body; a pump housing connected to the valve body and having an inlet and outlet formed therein; and a seat member mounted on the pump housing and changing the moving direction of fluid introduced through the inlet toward the plunger.

The plunger may include: a plunger body inserted into the valve body so as to slide inside the valve body; a concave groove formed in the plunger body; and a spherical member received in the concave groove, wherein contact between the spherical member and the plunger body is maintained through the pressure of the fluid.

The pump housing may include: an inlet forming a flow path through which fluid is introduced; an outlet forming a flow path through which the fluid introduced through the inlet is discharged to the outside; and a pump body part having a path connecting the inlet and the outlet.

The pump body part may include: a pump body having a body through-hole formed therein, to which the seat member is coupled and fixed; and an inlet through-hole formed in the pump body so as to connect the inlet and the body through-hole.

The seat member may include: a seat body mounted in the pump housing; a fluid introduction part formed in the seat body and guiding the fluid introduced through the inlet to the inside of the seat body; a direction change part connected to the fluid introduction part and opened toward the plunger so as to change the moving direction of the fluid introduced through the fluid introduction part toward the plunger; and a fluid discharge part concavely formed at the side of the seat body and guiding the fluid guided toward the plunger to the outlet.

The fluid introduction part may be concavely formed at the side of the seat body so as to communicate with the inlet.

The fluid introduction part may include a side fluid introduction part which is formed in such a manner that the cross-sectional shape thereof taken along a direction perpendicular to the moving direction of the plunger is narrowed toward the inside of the seat body.

The fluid introduction part may further include upper and lower fluid introduction parts restricting the movement of the fluid introduced through the inlet and guiding the fluid to enter the direction change part.

The direction change part may include: a direction change flow path formed in the seat body and changing the flow direction of the fluid introduced through the fluid introduction part toward the plunger; and an upper direction change part connected to the direction change flow path and having a concave shape to receive the spherical member.

The fluid discharge part may be formed in such a manner that the cross-sectional shape thereof taken along a direction perpendicular to the moving direction of the plunger is narrowed toward the inside of the seat body.

The seat body, the fluid introduction part, the direction change part, and the fluid discharge part may be integrally formed.

### BRIEF DESCRIPTION OF THE DRAWINGS

FIG. 1 is a cross-sectional view of a solenoid valve in accordance with an embodiment of the present invention, illustrating a state in which the solenoid valve is closed.

FIG. 2 is a schematic perspective view of a seat member in accordance with the embodiment of the present invention.

FIG. 3 is a side view of the seat member in accordance with the embodiment of the present invention.

FIGS. 4A and 4B are a plan view and rear view of the seat member in accordance with the embodiment of the present invention.

FIG. 5 is a cross-sectional view taken along line A-A′ of FIG. 1.

FIG. 6 is a diagram illustrating a state in which the solenoid valve in accordance with the embodiment of the present invention is opened.

FIG. 7 is a diagram illustrating a flow of fluid in a state where the solenoid valve in accordance with the embodiment of the present invention is opened.

FIG. 8 is a diagram illustrating a portion B of FIG. 6.

### DESCRIPTION OF SPECIFIC EMBODIMENTS

Embodiments of the invention will hereinafter be described in detail with reference to the accompanying drawings. It should be noted that the drawings are not to precise scale and may be exaggerated in thickness of lines or sizes of components for descriptive convenience and clarity only. Furthermore, the terms as used herein are defined by taking functions of the invention into account and can be changed according to the custom or intention of users or operators. Therefore, definition of the terms should be made according to the overall disclosures set forth herein.

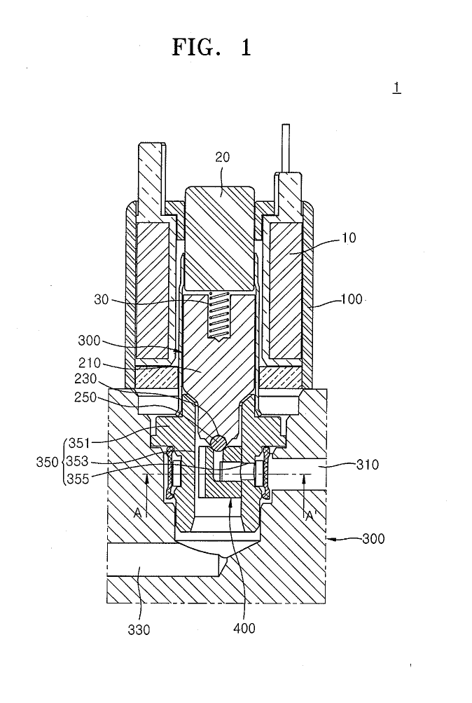

FIG. 1 is a cross-sectional view of a solenoid valve in accordance with an embodiment of the present invention, illustrating a state in which the solenoid valve is closed.

Referring to FIG. 1, the solenoid valve 1 in accordance with the embodiment of the present invention includes a valve body 100, a plunger 200, a pump housing 300, and a seat member 400.

For convenience of description, suppose that the solenoid valve 1 in accordance with the embodiment of the present invention is a normal close-type outlet solenoid valve of which the flow path is opened by an electromagnetic force when a current is applied to a coil 10.

The valve body 100 includes the coil 10 and a stator 20 provided therein, and the plunger 200 is inserted into the valve body 100 so as to reciprocate inside the valve body 100.

That is, when a current is applied to the coil 10 in a state where the plunger 200 is closely attached to the seat member 400 by an elastic force of a spring 30 as illustrated in FIG. 1, an electromagnetic force is generated between the stator 20 and the plunger 200 by an induced current between the coil 10 and the stator 20, and the plunger 200 is moved toward the stator 20 (the upper side of FIG. 1) by the electromagnetic force.

The plunger 200 is movably inserted into the valve body 100, and reciprocated inside the valve body 100 by a resultant force of the electromagnetic force generated from the stator 20, the elastic force of the spring 30, and the pressure of fluid flowing through the seat member 400.

That is, the electromagnetic force generated from the stator 20 and the force caused by the pressure of fluid introduced between the seat member 400 and the plunger 200 are applied upward to the plunger 200, and the elastic force of the spring 30 is applied downward to the plunger 200, based on FIG. 1.

Among the forces applied to the plunger 200, the electromagnetic force generated from the stator 20 is changed by the magnitude of a current applied from outside. Thus, the magnitude of the applied current may be adjusted to control the movement of the plunger 200.

In the present embodiment, the plunger 200 includes a plunger body 210, a concave groove 230, and a spherical member 250.

The plunger body 210 is slidably inserted into the valve body 100, and the upper part of the plunger body 210 is pressurized downward and supported by the spring 30.

The concave groove 230 is concavely formed at a lower end of the plunger body 210, and has a shape corresponding to the shape of the outer surface of the spherical member 250 such that the spherical member 250 is received in the concave groove 230.

The spherical member 250 is formed in a spherical shape, and the contact between the spherical member 250 and the plunger body 210 is maintained by the pressure of fluid to pressurize the spherical member 250. The spherical member 250 is moved with the plunger body 210.

In the present embodiment, when the plunger body 210 is moved downward, the spherical member 250 comes in contact with an upper direction change part 453 to be described below, thereby selectively blocking the movement of fluid through the seat member 400.

The pump housing 300 is connected to the valve body 100, or particularly, the lower part of the valve body 100 through bolting or the like, and has an inlet 310 and outlet 330 formed therein.

In the present embodiment, the pump housing 300 includes the inlet 310, the outlet 330, and a pump body part 350.

The inlet 310 corresponds to a flow path through which fluid is supplied. In the present embodiment, the inlet 310 is a flow path through which fluid is introduced. The outlet 330 corresponds to a flow path through which the supplied fluid is discharged to the outside.

The seat member 400 is received on the pump body part 350, and the pump body part 350 has a path connecting the inlet 310 and the outlet 330 such that the fluid is transferred through the path.

In the present embodiment, the pump body part 350 includes a pump body 351, a body through-hole 353, and an inlet through-hole 355.

In the present embodiment, the body through-hole 353 of the pump body 351 is formed in a vertical direction in FIG. 1, and the seat member 400 is coupled and fixed to the body through-hole 353.

The inlet through-hole 355 is a flow path formed in the pump body 351, and connects the inlet 310 and the body through-hole 353.

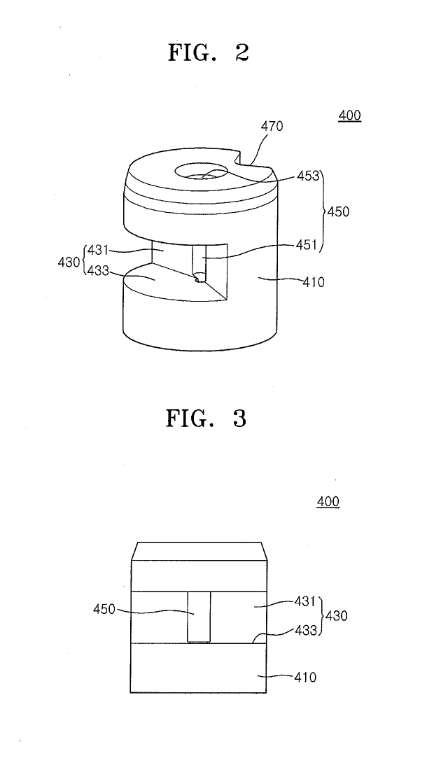

FIG. 2 is a schematic perspective view of the seat member in accordance with the embodiment of the present invention. FIG. 3 is a side view of the seat member in accordance with the embodiment of the present invention.

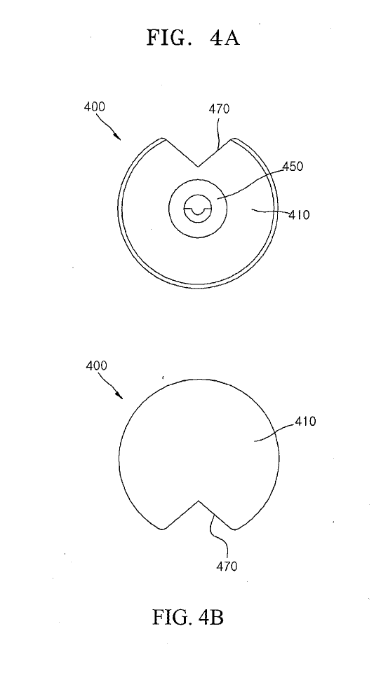

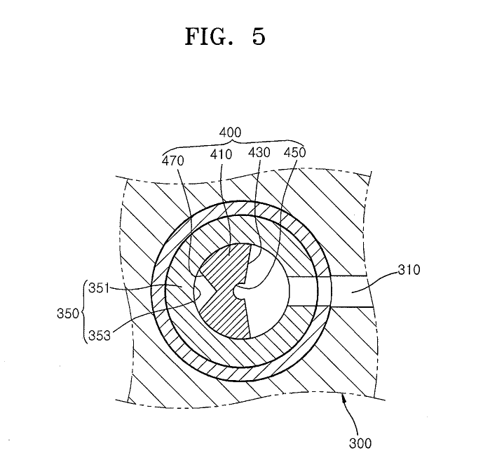

FIGS. 4A and 4B are a plan view and rear view of the seat member in accordance with the embodiment of the present invention. FIG. 5 is a cross-sectional view taken along line A-A′ of FIG. 1.

Referring to FIGS. 2 to 5, the seat member 400 is mounted on the pump housing 300, and changes the moving direction of the fluid introduced through the inlet 310 toward the plunger 200.

In the present embodiment, the seat member 400 includes a seat body 410, a fluid introduction part 430, a direction change part 450, and a fluid discharge part 470.

The seat body 410 is mounted on the pump housing 300. In the present embodiment, the seat body 410 has a cylindrical shape, and is inserted and coupled to the body through-hole 353 formed in the pump body 351.

The fluid introduction part 430 is formed in the seat body 410, and guides the fluid introduced through the inlet 310 to the inside of the seat body 410.

In the present embodiment, the fluid introduction part 430 is concavely formed at the side of the seat body 410 so as to communicate with the inlet 310, and connected to the direction change part 450 so as to guide the fluid introduced through the inlet 310 to the direction change part 450.

In the present embodiment, the fluid introduction part 430 includes a side fluid introduction part 431 and upper and lower fluid introduction parts 433.

The side fluid introduction part 431 restricts the side-to-side movement of the fluid introduced through the inlet 310 in FIG. 3 such that the fluid enters the direction change part 450.

In the present embodiment, the fluid introduction part 430, or particularly, the side fluid introduction part 431 is formed in such a shape that the cross-sectional shape thereof taken along the direction perpendicular to the moving direction of the plunger 200 is narrowed toward the inside of the seat body 410.

FIG. 5 illustrates the cross-sectional shape of a plane taken along the direction perpendicular to the moving direction of the plunger 200. Referring to FIG. 5, the side fluid introduction part 431 is formed in such a shape that the cross-sectional shape thereof is narrowed from the right side toward the left side. Thus, the fluid is guided to the direction change part 450 by the side fluid introduction part 431.

The upper and lower fluid introduction parts 433 restrict the upward and downward movement of the fluid introduced through the inlet 310, substantially prevents the fluid from escaping from the seat body 410 to the outside, and guides the fluid to enter the direction change part 450.

The direction change part 450 is connected to the fluid introduction part 430, opened toward the plunger 200, and changes the moving direction of the fluid guided through the fluid introduction part 430 toward the plunger 200.

In the present embodiment, the direction change part 450 includes a direction change flow path 451 and an upper direction change part 453.

The direction change flow path 451 is a flow path formed in the seat body 410 to change the flow of the fluid introduced through the fluid introduction part 430 toward the plunger. The direction change flow path 451 is formed in the vertical direction of FIG. 1, and changes the moving direction of the fluid guided through the fluid introduction part 430 toward the plunger 200, that is, the upper side of FIG. 1.

In the present embodiment, the direction change flow path 451 is formed in such a manner that the upper side thereof is opened. The upper opening is selectively opened and closed by the spherical member 250 as the plunger body 210 is moved.

The upper direction change part 453 is positioned at the top of the direction change part 451, and the spherical member 250 is received on the upper direction change part 453 as the plunger body 210 is moved. In the present embodiment, the upper direction change part 453 is concavely formed to correspond to the shape of the spherical member 250 at the top of the seat member 400.

The fluid discharge part 470 is concavely formed at the side of the seat body 410 along the vertical direction of FIG. 1, and guides the fluid discharged to the top of the seat body 410 through the direction change part 450 toward the outlet 330.

In the present embodiment, the fluid discharge part 470 is formed in such a manner that the cross-sectional shape thereof taken along the direction perpendicular to the moving direction of the plunger 200 is narrowed toward the inside of the seat boy 410, that is, the right side of FIG. 5. The fluid is moved between the fluid discharge part 470 and the pump body 351 and then discharged to the outlet 330.

In the present embodiment, the seat body 410, the fluid introduction unit 430, the direction change part 450, and the fluid discharge part 470 are integrally formed. Since the seat body 400 is provided as a single part, the management for the part may be facilitated, and the durability of the part may be improved.

Hereafter, the operation principle of the solenoid valve 1 in accordance with the embodiment of the present invention will be described as follows.

Referring to FIG. 1, the plunger body 210 is pressurized and supported toward the seat member 400 by the spring 30 to pressurize the plunger body 210 from the top.

In such a state, since the upper direction change part 453 is closed by the spherical member 250, the fluid of the inlet 310 is not moved toward the outlet 330.

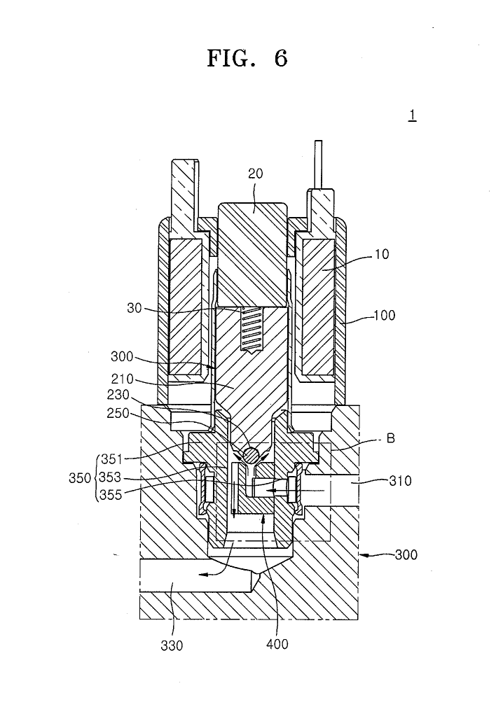

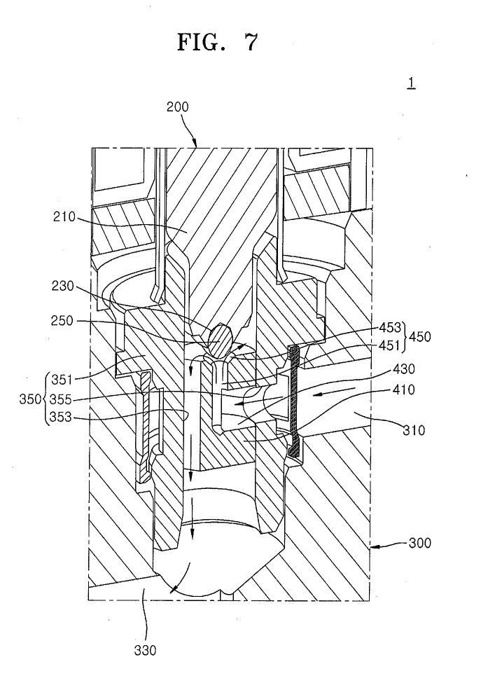

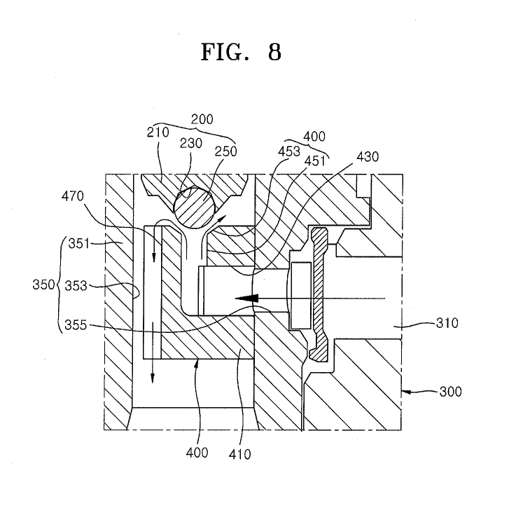

FIG. 6 is a diagram illustrating a state in which the solenoid valve in accordance with the embodiment of the present invention is opened. FIG. 7 is a diagram illustrating a flow of fluid in a state where the solenoid valve in accordance with the embodiment of the present invention is opened. FIG. 8 is a diagram illustrating a portion B of FIG. 6.

Referring to FIGS. 6 to 8, a current is supplied to the coil 10 so as to lower the pressure of fluid positioned in the inlet 310.

When the supplied current is applied to the coil 10, a force to move the plunger body 210 upward is generated by an electromagnetic force between the stator 20 and the plunger body 210 through an induced current.

At this time, the spring 30 applies an elastic force to push the plunger body 210 downward, the stator 20 applies a force to pull the plunger body upward, and the pressure of the fluid positioned in the direction change part 450 applies a force to push the plunger body 210 upward.

When the magnitude of the current applied to the coil 10 is increased, the magnitude of the electromagnetic force of the stator 20 to pull the plunger body 210 increases.

When a resultant force of the electromagnetic force applied to the plunger body 210 and the force to push the plunger body 210 in the upward direction of FIG. 6 through the pressure of the fluid is larger than the elastic force of the spring 30 to pressurize the plunger body 210 in the downward direction, the plunger 200 is moved upward to open the top of the direction change part 450.

When the top of the direction change part 450 is opened, the fluid positioned in the inlet 310 is discharged to the top of the seat member 400 along the direction change part 450, and then transferred to the outlet 330 through the fluid discharge part 470 disposed at the side of the seat body 410.

The pressure of the fluid positioned in the inlet 310 is lowered while the fluid is moved to the top of the seat member 400 through the direction change part 450 and then moved to the outlet 330 through the fluid discharge part 470.

When the current applied to the coil 10 is broken, the electromagnetic force of the stator 20 to pull the plunger body 210 is released, and the plunger body 210 is moved toward the seat member 400 by the elastic force of the spring 30.

As the plunger body 210 is moved, the spherical member 250 is contacted with the upper direction change part 453 so as to close the top of the direction change flow path 451. Then, the fluid is blocked from moving through the direction change part 450.

The fluid is moved toward the plunger body 210 in a state where the fluid is temporarily stored in the fluid introduction unit 430 and the direction change part 450. Thus, since the movement of the fluid is linearly guided, the pulsation of the fluid is reduced, and the pressure of the fluid may be linearly controlled.

In the solenoid valve 1 in accordance with the embodiment of the present invention, the fluid introduction part 430 is formed in such a manner that the cross-sectional shape thereof is narrowed toward the inside of the seat body 410. Thus, the fluid introduced from the inlet 310 may be easily guided to the inside of the seat body 410.

Furthermore, the fluid discharge part 470 is formed at the side of the seat body 410 so as to guide the fluid toward the outlet 330. Thus, the fluid discharge part 470 may facilitate the discharge of the fluid, and may be easily manufactured because it has a simple structure.

Furthermore, the fluid introduction part 430 and the fluid discharge part 470 are concavely formed at the side of the seat body 410. Thus, the fluid introduction part 430 and the fluid discharge part 470 may facilitate the introduction and discharge of the fluid, and may be easily manufactured because they have a simple structure.

Furthermore, since the seat body 410, the fluid introduction part 430, the direction change part 450, and the fluid discharge part 470 are integrally formed, the parts may be easily manufactured and assembled, and the manufacturing cost may be reduced.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. A solenoid valve comprising:
a valve body;
a plunger inserted into the valve body so as to reciprocate inside the valve body;
a pump housing connected to the valve body and having an inlet and outlet formed therein; and
a seat member mounted on the pump housing and changing the moving direction of fluid introduced through the inlet toward the plunger.

2. The solenoid valve of claim 1, wherein the plunger comprises:
a plunger body inserted into the valve body so as to slide inside the valve body;
a concave groove formed in the plunger body; and
a spherical member received in the concave groove,
wherein contact between the spherical member and the plunger body is maintained through the pressure of the fluid.

3. The solenoid valve of claim 1, wherein the pump housing comprises:
an inlet forming a flow path through which fluid is introduced;
an outlet forming a flow path through which the fluid introduced through the inlet is discharged to the outside; and
a pump body part having a path connecting the inlet and the outlet.

4. The solenoid valve of claim 3, wherein the pump body part comprises:
a pump body having a body through-hole formed therein, to which the seat member is coupled and fixed; and
an inlet through-hole formed in the pump body so as to connect the inlet and the body through-hole.

5. The solenoid valve of claim 1, wherein the seat member comprises:
a seat body mounted in the pump housing;
a fluid introduction part formed in the seat body and guiding the fluid introduced through the inlet to the inside of the seat body;
a direction change part connected to the fluid introduction part and opened toward the plunger so as to change the moving direction of the fluid introduced through the fluid introduction part toward the plunger; and
a fluid discharge part concavely formed at the side of the seat body and guiding the fluid guided toward the plunger to the outlet.

6. The solenoid valve of claim 5, wherein the fluid introduction part is concavely formed at the side of the seat body so as to communicate with the inlet.

7. The solenoid valve of claim 6, wherein the fluid introduction part comprises a side fluid introduction part which is formed in such a manner that the cross-sectional shape thereof taken along a direction perpendicular to the moving direction of the plunger is narrowed toward the inside of the seat body.

8. The solenoid valve of claim 7, wherein the fluid introduction part further comprises upper and lower fluid introduction parts restricting the movement of the fluid introduced through the inlet and guiding the fluid to enter the direction change part.

9. The solenoid valve of claim 5, wherein the direction change part comprises:
a direction change flow path formed in the seat body and changing the flow direction of the fluid introduced through the fluid introduction part toward the plunger; and
an upper direction change part connected to the direction change flow path and having a concave shape to receive the spherical member.

10. The solenoid valve of claim 5, wherein the fluid discharge part is formed in such a manner that the cross-sectional shape thereof taken along a direction perpendicular to the moving direction of the plunger is narrowed toward the inside of the seat body.

11. The solenoid valve of claim 5, wherein the seat body, the fluid introduction part, the direction change part, and the fluid discharge part are integrally formed.
